(19) United States
(12) Patent Application Publication
(10) Pub. No.: US 2008/0129542 A1
(43) Pub. Date: Jun. 5, 2008

(54) Structure of traffic light

(76) Inventor: I-Ching Chen, I Lan City (TW)

Correspondence Address: BIRCH STEWART KOLASCH & BIRCH, PO BOX 747, FALLS CHURCH, VA, 22040-0747, US

(21) Appl. No.: 11/633,557

(22) Filed: Dec. 5, 2006

(51) Int. Cl. G08G 1/095

(52) U.S. Cl. 340/907

(57) ABSTRACT

An improved structure of traffic light is mainly to install in a signal box at least one illuminant unit, which is a square or round lantern composed of a plurality of LED lamps arrayed in matrix or honeycomb. And, the LED lamps comprised in the illuminant unit are in monochrome red, yellow and green and arrayed in checkered pattern to display red, yellow and green lights. Design of the illuminant unit effectively reduces weight and dimensions of the signal box so as to result in cost reduction.

### BACKGROUND OF THE INVENTION

I. Field of the Invention

The present invention relates to an “improved structure of traffic light”, particularly, to a structure that can reduce the dimensions, weight and cost of the signal box by using only one illuminant unit to display red, yellow and green lights or such signals as character “X” and numbers according to the traffic signal control.

II. Description of the Prior Art

Generally speaking, the structure of the traffic light of prior art is to install three illuminant devices in a signal box to display red, yellow and green light respectively; or, to have three separate signal boxes, each including an illuminant device. The said illuminant device usually comprises tungsten-filament lamps or LED light units.

According to the foregoing traffic light of prior art, there are at least three signal boxes mounted on a pole for respectively displaying red, yellow and green light. Structure like such exhibits drawbacks as follows:

1. Higher cost: The structure of the pole (beam) must be very rigid so as to hang a plurality of signal boxes that form large dimensions and heavy weight.

2. Higher risk: Wind load is a critical issue for large traffic lights of prior art and is even more problematic for those erected on Taiwan, a place frequently struck by typhoons. During typhoon seasons, a large surface on the island is swiped by strong winds. Many of the large traffic lights of prior art are damaged. Therefore, it would be risky to propose future installation of the traffic lights of prior art.

3. Visual obstacle: The large traffic lights of prior art mounted on poles situated on street corners are rather obstacles that hinder the drivers' sight for causing accidents.

To improve the foregoing drawbacks, an improved structure of traffic light of prior art has been introduced. It is to install in a signal box at least one square or round illuminant unit comprising a plurality of LED lamps arrayed in matrix or honeycomb; the characteristic lies in: each LED lamp is a multi-chip LED (Light Emitting Diode) that contains at least red and green light emitting chips so as to emit monochrome red, green or yellow light. This design is in consideration that the RGB LED lamps (mixing RGB colors) have shorter service life in comparison with the monochrome LED lamps.

In addition, the foregoing improved structure of traffic light of prior art comprises a flat-cap shade or a tube-shaped shade installed on the front of the signal box. Nevertheless, the shade in flat-cap shape cannot stop external light interference to the lights and causes visual confusion by exposing the lights to drivers in side lanes that. Visual confusion is a critical issue for driving safety. Therefore, further improvement on the shade and the signal box needs to be addressed.

### SUMMARY OF THE INVENTION

To improve the foregoing drawbacks, an “improved structure of traffic light” of the present invention is disclosed hereby.

Main objective of the present invention is to provide an improved structure of traffic light that comprises an illuminant unit which is a square or round lantern composed of monochrome red, yellow and green. LED lamps arrayed in matrix or honeycomb so as to reduce the cost and prolong the service life.

Secondary objective of the present invention is to provide an improved structure of traffic light, wherein a tube-shaped shade is installed on the front of the signal box, and there is a plurality of openings on the tube of the shade. The openings are closed with doors that automatically open while encountering strong aerodynamic drag. This design not only attains to reduce the aerodynamic drag but also retains advantages of the tube-shaped shade—the lights enclosed in the tube of the shade can be kept from external light interference and only be seen from the front so as not to cause visual confusion to drivers in side lanes.

To achieve the foregoing objectives, the improved structure of traffic light of the present invention is mainly to install in a signal box at least one illuminant unit, which is a square or round lantern composed of a plurality of LED lamps arrayed in matrix or honeycomb to display red, yellow or green light; the characteristic lies in: the LED lamps are monochrome red, yellow and green and arrayed in checkered pattern.

The foregoing improved structure attains, therefore, to provide a multifunctional traffic light that has one illuminant unit in the signal box to display red, yellow or green light according to the traffic signal control. The multifunctional traffic light is thus granted with advantages of low cost, low wind load and compact dimensions. With regard to the LED lamps comprised in the illuminant unit, the present invention proposes the monochrome red, yellow and green LED lamp, instead of the RGB mix LED lamp. The monochrome LED lamp is illuminated by specific chips within the lamp. The chips usually take little processing time and cause less heat that consequently prolongs life of the chips. Accordingly, service life of the monochrome LED lamp is prolonged. It means that service life of the multifunctional traffic light is prolonged that results in optimized cost effectiveness. Altogether, the structure of the present invention achieves in providing a multifunctional traffic light that possesses both practicability and economic value.

With reference to the foregoing multifunctional traffic light, a tube-shaped shade is installed on the front of the signal box to cap the illuminant unit. However, the shade protruded from the front would easily cause aerodynamic drag. Therefore, the tube of the shade is cut with a plurality of openings for regulating the airflow in the tube so as to reduce the aerodynamic drag. However, the openings are closed with doors in view they would cause external light interference to the lights and light leakage. The door, which is affixed to upper edge of the opening by a three-loop butt hinge that contains a coil spring, automatically opens when the aerodynamic drag becomes stronger than the pressure on the coil spring. Furthermore, the tube-shaped shade that successfully stops external light interference and light leakage provides optimal visual effect and causes no visual confusion to drivers in side lanes.

### BRIEF DESCRIPTION OF THE DRAWINGS

FIG. 1 is a three-dimensional exploded diagram of the invention.

FIG. 2 is a three-dimensional view of the assembly of the invention.

FIG. 3 is a sectional view of the illuminant unit of the invention.

FIG. 4 is a front view showing another embodiment of the invention.

### DESCRIPTION OF THE PREFERRED EMBODIMENTS

Desirable features of the present invention will be better understood from the detailed description and drawings that follow, in which various embodiments of the disclosed invention are illustrated by way of example.

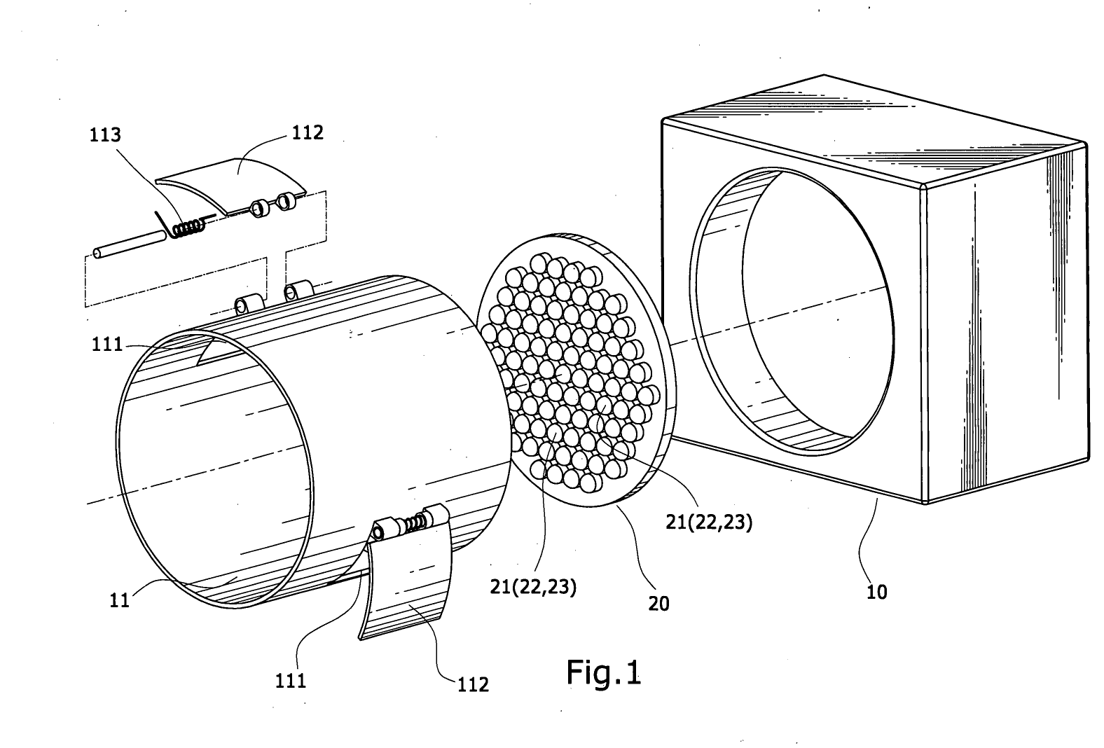

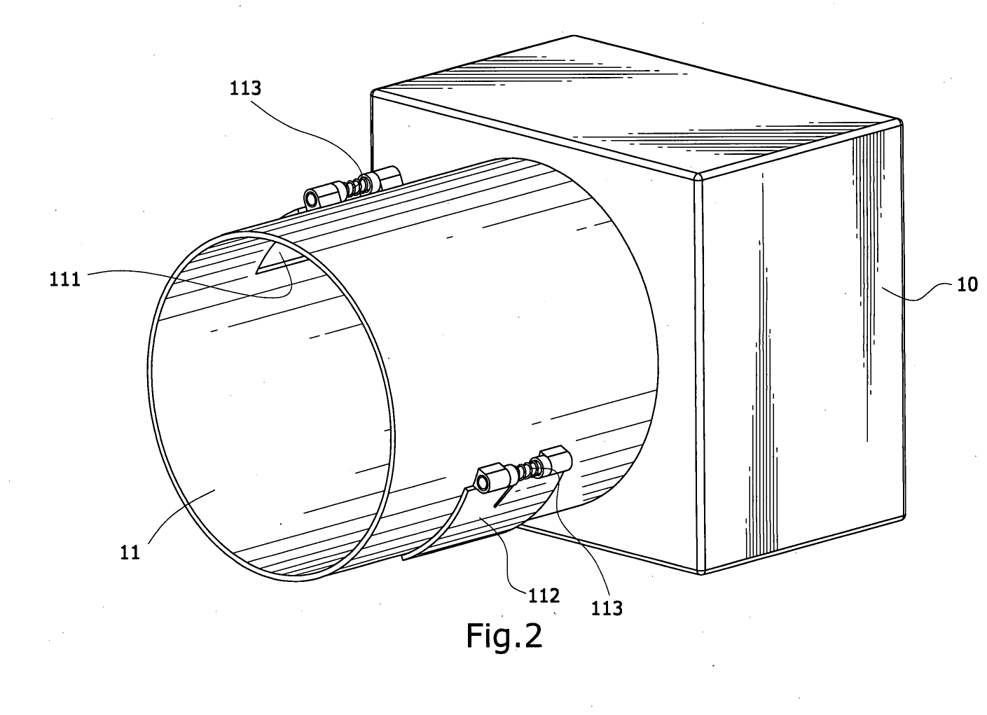

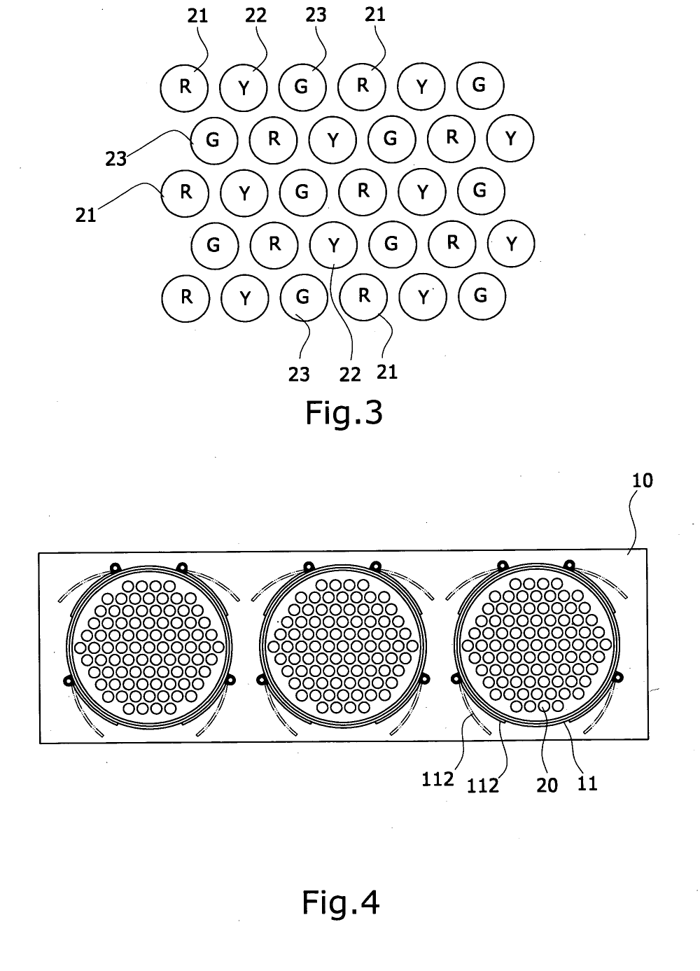

With reference to FIGS. 1, 2 and 3, the improved structure of traffic light of the present invention mainly comprises a signal box 10 that encloses at least one illuminant unit 20. The illuminant unit 20 is a square or round lantern composed of a plurality of LED lamps 21, 22, 23 arrayed in matrix or honeycomb so as to display red, yellow and green lights; and, the characteristic lies in: the illuminant unit 20 comprises a plurality of monochrome red, yellow and green LED lamps 21, 22, 23 arrayed in a checkered pattern (see FIG. 3).

The foregoing structure, which can use one illuminant unit 20 to display red, green or yellow light according to the traffic signal control, attains to provide a multifunctional traffic light that reduces the wind load and provides drivers with broader field of vision. Besides, the illuminant unit 20 is composed of monochrome LED lamps, instead of RGB mix LED lamps. Compared with the RGB mix LED lamp, the monochrome LED lamp has, in general, longer service life as being illuminated by specific chips within the lamp. Under the circumstances, the chips usually take little time to process and cause less heat. The chip can thus have longer life to support the monochrome LED lamp. Accordingly, service life of the multifunctional traffic light is prolonged that results in optimized cost effectiveness. Altogether, the structure of the present invention achieves in providing a multifunctional traffic light that possesses both practicability and economic value.

Once again, with reference to the foregoing multifunctional traffic light, wherein a tube-shaped shade 11 is installed on the front of the signal box 10 to cap the illuminant unit 20 (as seen in FIG. 1, 2). And, the tube of the shade 11 comprises a plurality of openings 111. The openings 111 are closed by doors 112 affixed by three-loop butt hinge that contains a coil spring 113. Position of the opening 111 is inclined to the signal box 10 at angle 30 to 60 degrees; however, the angle 45 degrees would be optimal.

Design of the foregoing opening 111 is for the purpose of reducing the aerodynamic drag. The tube-shaped shade 11, which is protruded from the front of the signal box 10, would easily cause aerodynamic drag. It thus needs openings 111 to regulate the airflow in the tube of the shade 11 so as to reduce the aerodynamic drag. The openings 111 are closed by doors 112. But, when the aerodynamic drag is stronger than the pressure on the coil spring 113, the doors 112 automatically open to let the airflow escape from the opening 111. The aerodynamic drag would be further reduced if position of the opening 111 is inclined to the signal box 10 at angle 45 degrees. Because this angle of inclination would prevent swings of the door 112 from being interfered with the adjacent shades, as seen in FIG. 4. Additionally, the tube-shaped shade 11 can provide optimal visual effect and cause no visual confusion so as to enhance the driving safety. The shade 11 stops external light interference by enclosing the lights in the tube. The lights can thus provide clearer effect. The lights enclosed in the tube can only be seen from the front that would not cause visual confusion to drivers in side lanes.

While the invention is susceptible to various modifications and alternative forms, specific embodiments have been shown by way of example in the drawings and described in detail herein. However, it should be understood that the invention is not intended to be limited to the particular form disclosed. Rather, the invention is to cover all modifications, equivalents, and alternatives falling within the spirit and scope of the invention as defined by the appended claims.

To sum up, the “improved structure of traffic light” disclosed by the present invention attains to reduce the wind load and equipment cost as well as to prolong the service life.

What is claimed is:

1. An improved structure of traffic light is mainly to install in a signal box at least one illuminant unit, which is a square or round lantern composed of a plurality of LED lamps arrayed in matrix or honeycomb to display red, yellow and green lights; the characteristic lies in:
the illuminant unit comprises a plurality of monochrome red, yellow and green LED lamps arrayed in checkered pattern.

2. The improved structure of traffic light of claim 1, a tube-shaped shade that caps the illuminant unit is protruded from the front of the signal box. Tube of the shade comprises a plurality of openings for automatically regulating the airflow in the shade. However, the openings are mostly kept closed with doors affixed by a three-loop butt hinge that contains a coil spring.

3. The improved structure of traffic light of claim 1, wherein position of the opening is inclined to the signal box at an angle 30 to 60 degrees.
